(19) United States
(12) Patent Application Publication
(10) Pub. No.: US 2010/0254781 A1
(43) Pub. Date: Oct. 7, 2010

(54) SHEET BINDING DEVICE AND BINDING METHOD

(75) Inventor: Hideaki Watanabe, Tokyo (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo, (JP)

(21) Appl. No.: 12/161,644

(22) PCT Filed: Mar. 3, 2008
(86) PCT No.: PCT/JP2008/000416

§ 371 Date: May 28, 2010

(30) Foreign Application Priority Data
Mar. 27, 2007 (JP) 2007-082424

(51) Int. Cl. B42B 5/00

(52) U.S. Cl. 412/33

(57) ABSTRACT

A sheet binding device and a binding method capable of binding stable sheets independently of sheet shape dimensions. The device operates by feeding a paper strap by strap feed rollers and a tape catcher, whereby the paper strap is clamped and rotated along a locus. In synchronization with this rotation, one hundred sheets are conveyed from left to right. The paper strap is wound round the one hundred sheets. A strap has a contact portion at its end, and the contact portion is permitted to make contact with the paper strap, and a cylindrical body is rotated at an angle formed between the one hundred sheets and the paper strap can be adjusted. If the angle of the binding portion exceeds one hundred sheets, the excess page count is equalized to an allowable value by the strap, thus preventing the curling of the sheets.

### TECHNICAL FIELD

The present invention relates to a sheet binding device loaded in a sheet processing apparatus to process sheets such as marketable securities and a binding method.

### BACKGROUND ART

The sheet processing apparatus for processing sheets such as marketable securities takes out and conveys sheets one by one from a sheet bundle supplied in a batch according to the processing unit by the take-out apparatus and discriminates the sheets by the sheet discrimination apparatus.

The sheet discrimination apparatus discriminates the kind of the concerned sheets (hereinafter, referred to as the bill kind), conveying direction, authenticity (authentic bill or counterfeit bill), and qualification (an authentic bill which is a recirculatable qualified bill or an authentic bill which is an unrecirculatable disqualified bill) and sorts them to qualified bills, disqualified bills, and rejection bills.

The sheets sorted in this way are stacked by the stacking device according to the sorting or are bound by the binding device.

Such a binding device feeds a paper strap by the strap feed motor, for example, winds the paper strap round one hundred stacked sheets (hereinafter, referred to as one hundred sheets), presses them, thereby winds strongly the paper strap round the sheets. Or, a method for winding a paper strap round sheets which are entirely curved, then eliminating the curvature of the sheets, thereby obtaining binding force of the paper strap is general and a method similar to it is known (for example, refer to Patent Document 1).

With reference to FIGS. 14 and 15, the curling of sheets by the conventional method will be explained. FIG. 14 is a drawing for explaining the condition that a paper strap K is wound round 100 hundred sheets PB and then a sheet P is curled. A strap feed motor 240 in the state shown in the drawing is rotated in the opposite direction, and the paper strap K is wound up, thus the one hundred sheets PB is bound by the paper strap K. However, according to this conventional method, for example, the shape dimension of the binding portion of the one hundred sheets PB is different between L1 and L2, so that when the paper strap K is wound up, an angle θ1 formed between the one hundred sheets PB and the paper strap K when the shape dimension of the one hundred sheets PB is L1 and an angle θ2 formed between the one hundred sheets PB and the paper strap K when the shape dimension of the one hundred sheets PB is L2 are different from each other. As a result, for example, if the paper strap K is wound up so that the angle θ1 or θ2 becomes larger than the allowable value, the force on the side of the paper strap K is increased and a phenomenon that several lower sheets P composing the one hundred sheets PB are wound up occurs (FIG. 15).

[Patent Document 1] Japanese Utility Model Application Publication No. 5-75105 (page 1, FIG. 2)

However, in the binding device described in Patent Document 1, for example, if sheets, like Euro paper moneys, are different in the sheet dimensions thereof depending on the bill kind, a problem arises that it is difficult to obtain stable binding force without damaging the one hundred sheets. Further, a problem arises that sheets may be apt to be damaged due to the bill quality.

Namely, when the aforementioned sheets (for example, Euro paper money) are a low-value bill, the shape dimension of the sheets is often short and when the sheets are a high-value bill, the shape dimension of the sheets is often long. Further, when the aforementioned sheets are qualified bills and disqualified bills, they are characterized in that the former is stiff and the latter is unstiff. Therefore, a problem arises that in either of the cases, it is difficult to bind the sheets free of damage.

The present invention was developed to solve the above problems and is intended to provide a sheet binding device and a binding method capable of binding stably sheets independently of the sheet shape dimensions.

### DISCLOSURE OF INVENTION

To accomplish the above object, the sheet binding device stated in Claim 1 of the present invention is a binding device for binding stacked sheets with a binding member, and it includes a conveying means for conveying the aforementioned sheets, a feeding means capable of rotating in both forward and backward directions to feed forward and backward the binding member, a clamping means for clamping the binding member fed by the feeding means, and a rotating means for rotating the clamping means from the leading edge side of the sheets in the conveying direction to the trailing edge side, and further includes a winding means for winding the binding member round the sheets, a strap holding means, when winding up the binding member wound round the sheets by the winding means by rotating the feeding means backward, to adjust the angle formed between the binding member and the sheets, for moving forward and backward the contact portion having the contact surface in contact with the binding member and the pressing surface for pressing the binding member to the sheets, a heat fusing means for heating and fusing the binding member, and a cutting means for cutting off the binding ember.

Further, the sheet binding method stated in Claim 5 of the present invention is a binding method of a binding device including a conveying means for conveying sheets, a feeding means capable of rotating in both forward and backward directions to feed forward and backward the binding member, a clamping means for clamping the binding member fed by the feeding means, a winding means for rotating the clamping means from the leading edge side of the sheets in the conveying direction to the trailing edge side and winding the binding member round the sheets, a pushing means, when winding up the binding member wound round the sheets by the winding means by rotating the feeding means backward, to adjust the angle formed between the binding member and the sheets, for moving forward and backward the contact portion having the contact surface in contact with the binding member and the pressing surface for pressing the binding member to the sheets, a heat fusing means for heating and fusing the binding member, and a cutting means for cutting off the binding ember and it includes a first step of conveying the sheets by the conveying means up to the binding start position, a second step of feeding the binding member by the feeding means until it passes the clamping means and projects by a predetermined amount, a third step, after end of the second step, of clamping the binding member projected by the predetermined amount, a fourth step, after end of the third step, of feeding the binding member by the feeding means, simultaneously rotating the clamping means counterclockwise, and in synchronization with the rotation, conveying furthermore the sheets in the conveying direction, a fifth step, after end of the fourth step, of permitting the contact surface of the contact portion to make contact with the binding member, rotating the cylindrical body, pushing it on the sheet side, thereby adjusting the angle between the sheets and the binding member, a sixth step, after end of the fifth step, of rotating backward the feeding means, winding up the binding member, thereby binding the sheets, a seventh step, after end of the sixth step, of rotating furthermore the cylindrical body, pushing the binding member to the sheets by the pressing surface of the contact portion, thereby preventing the binding member from loosening, an eighth step, after end of the seventh step, of cutting off the binding member, a ninth step, after end of the eighth step, of heat-fusing the binding members by the heat fusion means, and a tenth step, after end of the ninth step, of returning the damping means and contact portion to their initial states.

### BRIEF DESCRIPTION OF THE DRAWINGS

FIG. 1 is a perspective view showing the essential section of the stacking-binding device composed of a stacking device, a binding device, and a strap reel portion relating to Embodiment 1 of the present invention.

FIG. 2 is a drawing showing the constitution of the binding portion of the binding device shown in FIG. 1.

FIG. 3 is a drawing showing the tape catcher opened relating to the operation of the binding device shown in FIG. 2.

FIG. 4 is a drawing showing the condition that after the operation shown in FIG. 3, the paper strap is fed between the tape catcher by a fixed amount.

FIG. 5 is a drawing showing the condition that after the operation shown in FIG. 4, the tape catcher is closed and hold the paper strap.

FIG. 6 is a drawing showing the condition that the paper strap is wound round the one hundred sheets after the operation shown in FIG. 5.

FIG. 7 is a drawing showing the condition that the strap holding member moves up after the operation shown in FIG. 6.

FIG. 8 is a drawing showing the binding condition of the one hundred sheets with the paper strap after the operation shown in FIG. 7.

FIG. 9 is an illustration showing the effect of the ascending operation of the strap holding member shown in FIG. 8.

FIG. 10 is a drawing showing the operation of the strap holding member after the operation shown in FIG. 8.

FIG. 11 is a drawing showing the operation of the strap cutter after the operation shown in FIG. 10.

FIG. 12 is a drawing showing the heat fusion operation after the operation shown in FIG. 11.

FIG. 13 is a drawing showing the pull-out operation of the tape catcher and the return operation of the strap holding member after the operation shown in FIG. 12.

FIG. 14 is a drawing showing the binding condition of two kinds of sheets different in length.

FIG. 15 is a drawing showing the curling condition of one kind of sheets.

### DESCRIPTION OF THE PREFERRED EMBODIMENTS

Hereinafter, the embodiments of the present invention will be explained with reference to the accompanying drawings.

### Embodiment 1

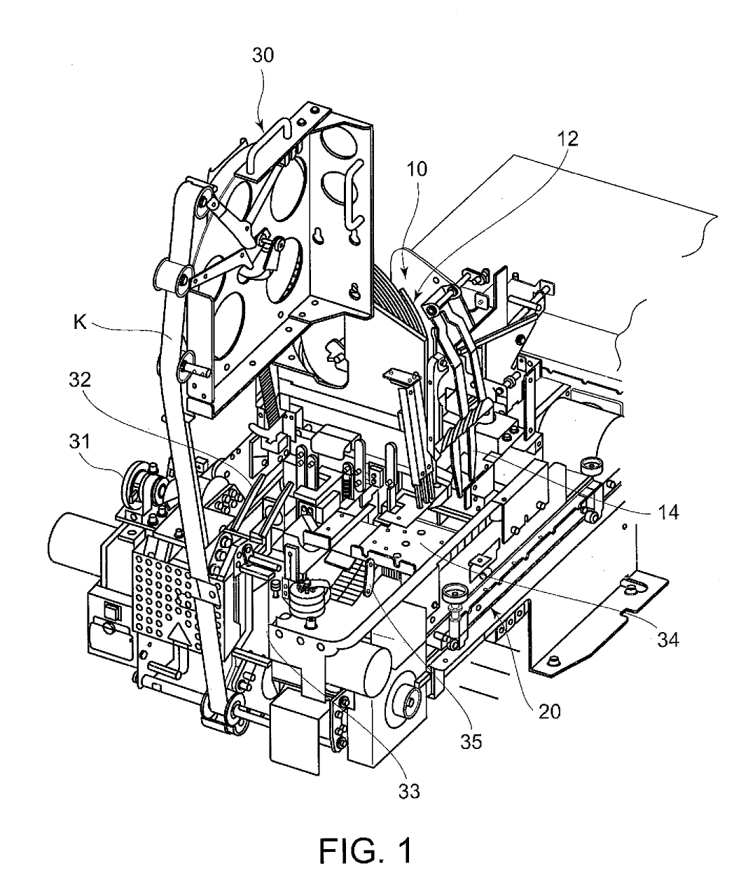

FIG. 1 is a perspective view showing the essential section of the stacking-binding device composed of a stacking device 10, a binding device 20, and a strap reel portion 30 relating to Embodiment 1 of the present invention.

The stacking device 10 is composed of a paddle wheel stacking device using a paddle wheel 12 as a method for absorbing kinetic energy of a sheet P conveyed at high speed to the transfer portion from the stacking storage (not drawn) for stacking the sheet P conveyed and simultaneously stacking the sheet P without damaging it.

The paddle wheel 12 has a plurality of paddles arranged around the rotary shaft and the sheet P is fetched between the paddles. The fetched sheet P rotates in correspondence with the rotation of the paddle wheel, and the kinetic energy thereof is absorbed, and the sheet P is stopped and scraped off by the sheet scraping plate (not drawn). In this case, a longitudinal aligning plate 14 for vibrating the end face of the sheet P and simultaneously aligning the sheet P in the longitudinal direction is arranged.

The sheet P scraped off in this way is stacked on the backup plate (not drawn) arranged on the bottom of the stacking storage.

The binding device 20 is a device for binding the one hundred sheets PB that the sheets P stacked on the backup plate of the stacking device 10 reach one hundred with the paper strap K which is a binding member. Therefore, the binding device 20 is composed of a carrier (not drawn) for moving the one hundred sheets PB from the backup plate of the stacking device 10 to the binding position, a tape winder 31 for feeding the paper strap K to bind the one hundred sheets PB moved with the paper strap (binding member) K and winding it round the PB, a damper 32 for clamping the one hundred sheets PB fed, and a heater 33 for heat-fusing the wound paper strap K. Furthermore, the binding device 20 is composed of a chute 34 for transferring the bundle formed by binding the one hundred sheets PB with the paper strap K to the next step and an aligning arm 35 for aligning the posture of the bundle transferred to the chute 34. Further, the bundle, for example, is referred to as a status that the one hundred sheets PB are wound with a strap.

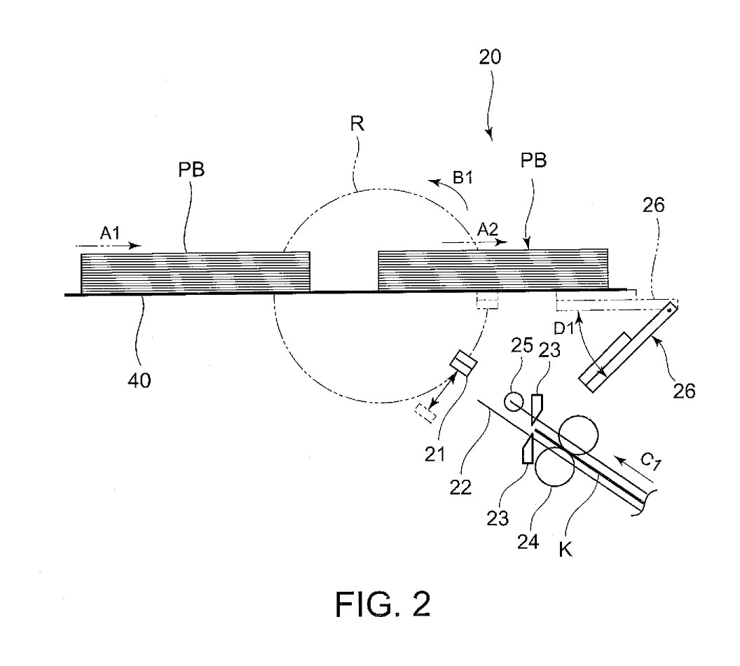

FIG. 2 is a drawing showing the constitution of the mechanism of the binding portion of the binding device 20 shown in FIG. 1. This mechanism is composed of a strap feed rollers (feeding means) 24 for feeding the paper strap K, a tape catcher (clamping means) 21 for rotating in the state of clamping the paper strap K, thereby winding the paper strap K round the one hundred sheets PB, strap cutters (cutting means) 23 for cutting off the paper strap K, a strap support roller 25 and a paper strap support guide 22 for supporting the paper strap K when feeding or rewinding the paper strap K, and a strap holding member (strap holding means) 26 for preventing the one hunched sheets PB wound from loosening when the paper strap K is cut off.

When the one hundred sheets PB shown in FIG. 2 are loaded on the carrier 40, are conveyed in the direction of the arrow A1 shown in the drawing by the conveying means, and reach the binding position of the one hundred sheets PB, the tape catcher 21 across the paper strap K rotate counterclockwise in the direction of the arrow B1 shown in the drawing, thus the one hundred sheets PB are bound with the paper strap K. At this time, the one hunched sheets PB1 are conveyed in the direction of the arrow A2 shown in the drawing furthermore from the binding position, and are simultaneously bound furthermore. The one hunched sheets PB are wound during conveyance in this way, thus the rotation locus of the tape catcher 21 can be made smaller.

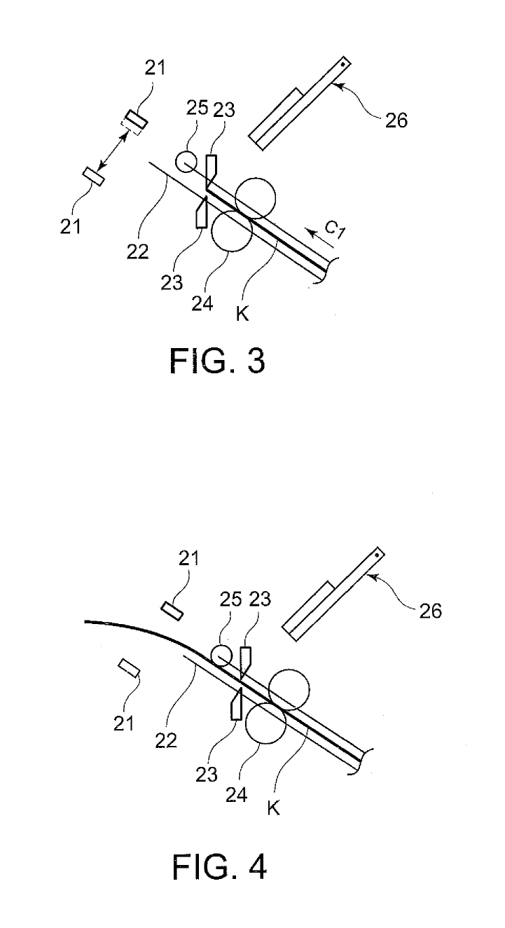

FIGS. 3 to 12 show the procedures of binding the one hundred sheets PB using the binding device 20.

Firstly, the one hundred sheets PB are conveyed to the binding start position (the first step). At the same time, the tape catcher 21 is opened to form a gap (FIG. 3) so as to clamp the paper strap (tape) K.

Next, the strap feed motor (not drawn) is driven to rotate forward the strap feed rollers (feeding means) 24 and the paper strap K is fed by a fixed amount into the gap between the opened tape catcher (clamping means) 21 (the second step shown in FIG. 4). Further, the strap feed rollers (feeding means) 24, to feed forward and backward the paper strap K which is a binding member, are structured so as to rotate forward and backward, and rotate forward when feeding the paper strap K and rotate backward when winding the paper strap K round the one hundred sheets PB.

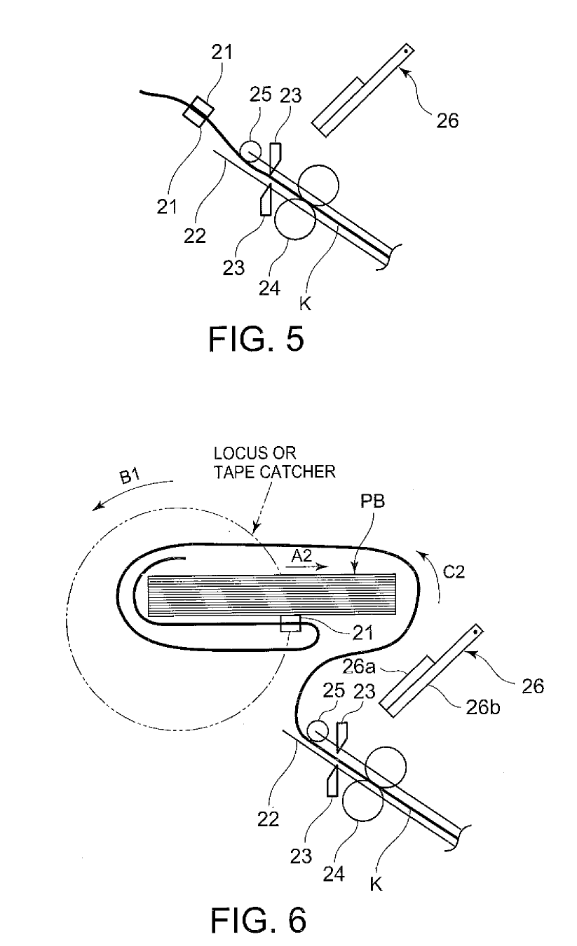

Next, the tape catcher 21 is closed (FIG. 5) and the fed paper strap K is clamped by the tape catcher 21 (the third step shown in FIG. 5).

By feeding the paper strap K by the strap feed rollers 24, the tape catcher 21, in the state that the paper strap K is clamped by them, rotate along the locus R shown in the drawing in the direction of the arrow B1 shown in the drawing. In synchronization with this rotation, the one hundred sheets PB are conveyed from left to right in the direction of the arrow A2 shown in the drawing (the fourth step shown in FIG. 6).

By this series of operations, the paper strap K is wound round the one hundred sheets PB.

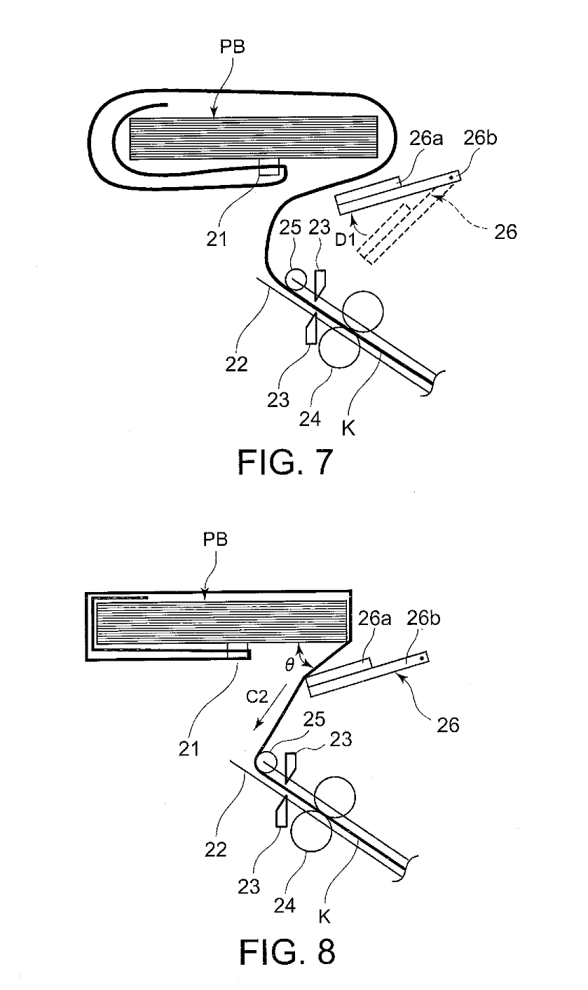

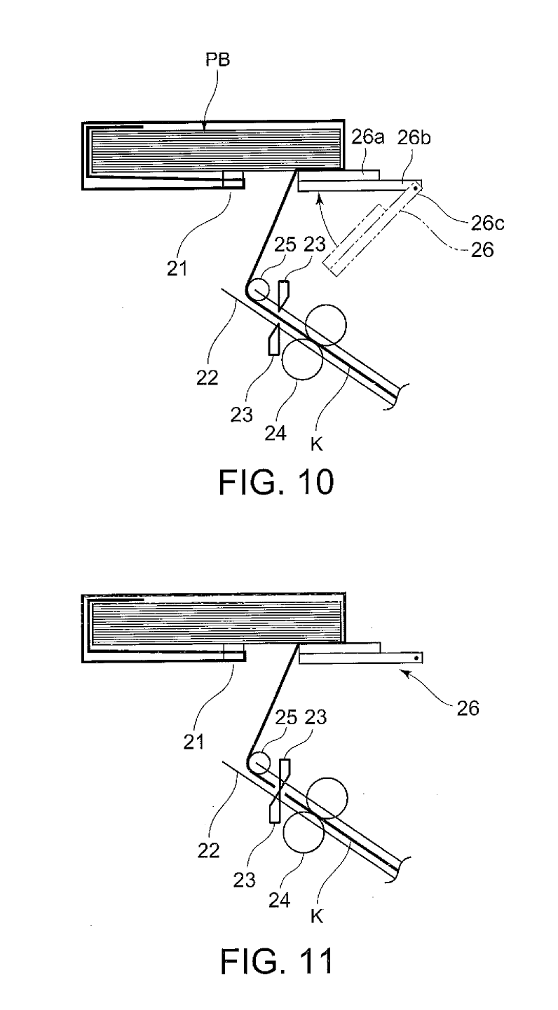

In this embodiment, before winding up the paper strap K, the strap holding member 26 is moved up (approaching) on the side of the one hundred sheets PB. The strap holding member 26, as shown in FIG. 10, has a main body 26b composed of a rotatable cylindrical body, in which one end 26c is supported and the other end has a contact portion 26e integrally composed of a contact portion 26a in contact with the paper strap K and a pressing surface 26d for pressing the paper strap K to the one hundred sheets PB. The contact portion 26a is permitted to make contact with the paper strap K, and the main body 26b is rotated, thus the angle θ formed between the one hundred sheets PB and the paper strap K is adjusted (the fifth step shown in FIG. 7).

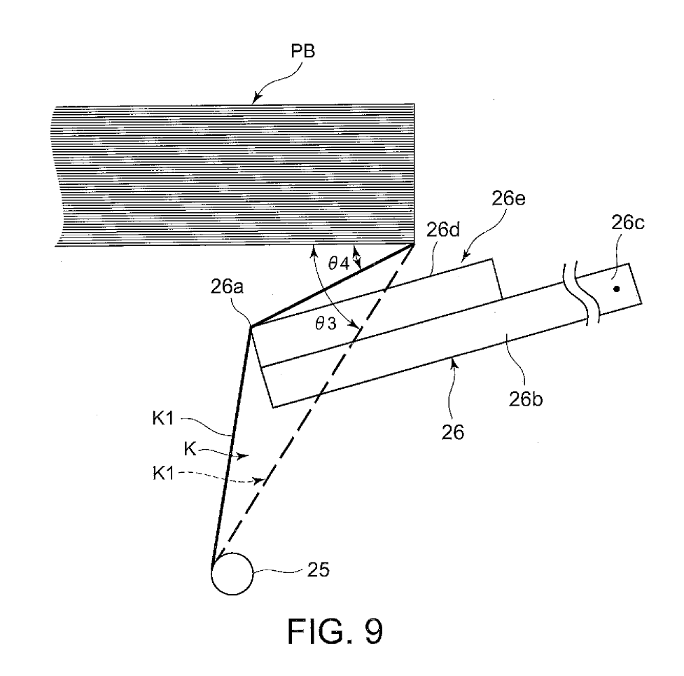

FIG. 8 is a drawing showing the binding condition of the one hundred sheets PB with the paper strap K. FIG. 9 is an illustration for explaining the effect of the ascending operation of the strap holding member 26. Hereinafter, by referring to FIGS. 8 and 9, the operation of the strap holding member 26 and the effect thereof will be explained.

If the strap holding member 26 moves up, when the paper strap K is wound up at a fulcrum of the leading edge of the strap holding member 26, the angle θ formed between the paper strap K and the one hundred sheets PB can be switched from an angle θ3 when the strap holding member 26 does not move up to an angle θ4 when the strap holding member 26 moves up. At this time, the relationship between the angles θ3 and θ4 is expressed by Formulas (1) and (2) indicated below.

θ4<θ3 (1)

θ4≦θS (2)

where θ3 is an angle formed between the one hundred sheets and the paper strap when the paper strap K is not held by the strap holding member 26,

θ4 is an angle formed between the one hundred sheets and the paper strap when the paper strap K is held by the strap holding member 26, and

θS is an allowable value of the angle formed between the one hundred sheets and the paper strap K.

For example, even if the angle θ3 of the binding portion of the one hundred sheets is a large value, so as to conform to Formula (2) by the strap holding member 26, it is made equal to the allowable value θS or smaller, thus the curling of the one hundred sheets PB can be prevented.

Next, the strap feed rollers 24 are rotated reversely, and the one hundred sheets PB are bound at predetermined force, and the binding by the paper strap K is completed (the sixth step shown in FIG. 8).

Thereafter, the strap holding member 26 is moved up furthermore and the paper strap K is pressed strongly to the one hundred sheets PB (the seventh step shown in FIG. 10).

The paper strap K is prevented from loosening by the aforementioned method and then the paper strap K is cut off by the strap cutters 23 (the eighth step shown in FIG. 11).

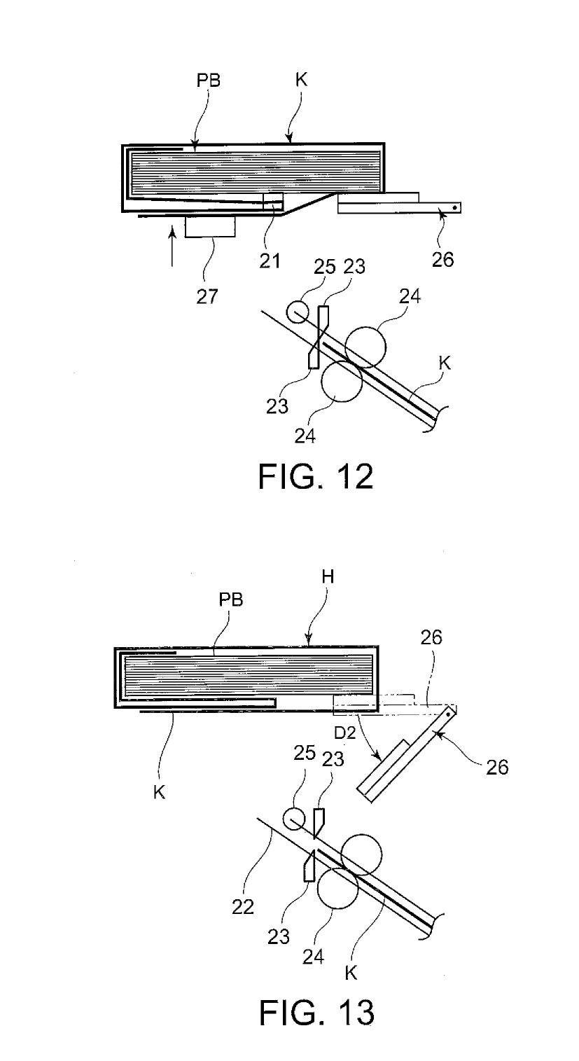

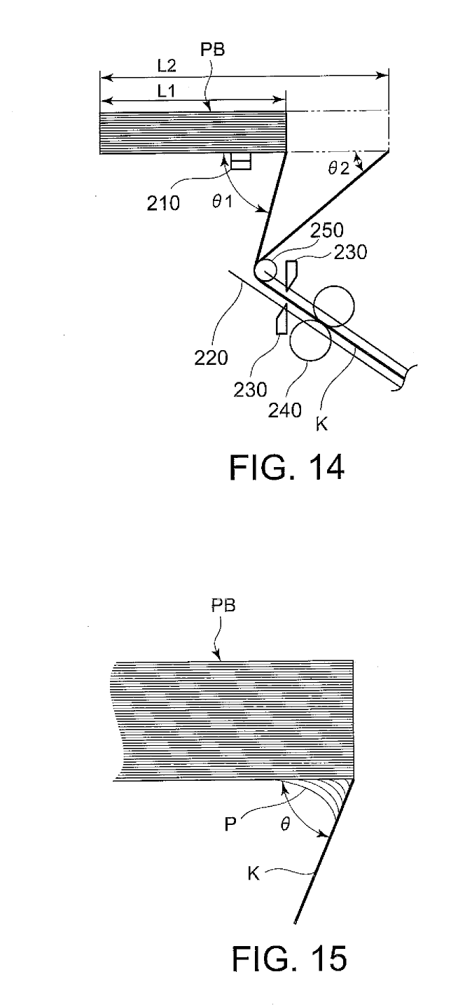

Next, the end face of the paper strap K is heated by a heater mechanism 27 and the wound paper straps are adhered to each other. Further, the paper strap K is coated with heat fusion paste on the back thereof and it is fused by heating and is heat-fused by pressing. In this embodiment, the backs of the paper straps K which are heat fusion portions are adhered to each other (the ninth step shown in FIG. 12).

Next, the tape catcher 21 is pulled out, and then the strap holding member 26 is returned to its original position, thus the binding process is finished, and a bundle His formed (the tenth step shown in FIG. 13).

As explained above, according to the binding device and binding method of the present invention, even if the binding portion of the one hundred sheets PB is large or small in shape depending on the bill kind, the one hundred sheets PB can be bound without damaging the binding portion.

Further, if the handling bills are disqualified bills, they are unstiff and the bill ends are apt to hang down and break, so that the angle control by the strap holding member 26 produces a high effect.

### INDUSTRIAL APPLICABILITY

According to the present invention, independently of the shape dimensions of sheets, the sheets can be bound stably.

1. A sheet binding device comprising:
conveying means for conveying stacked sheets;
feeding means capable of rotating forward and backward for feeding forward and backward a binding member;
clamping means for clamping the binding member fed by the feeding means;
winding means for rotating the binding member clamped by the clamping means from a leading edge side of the sheets in a conveying direction to a trailing edge side and winding the binding member round the sheets; and
strap holding means, when winding up the binding member wound round the sheets by the winding means by rotating the feeding means backward, so as to adjust an angle formed between the binding member and the sheets, for holding the binding member.

2. The sheet binding device according to claim 1 further comprising:
heat fusing means for heating and fusing the binding member; and
cutting means for cutting off the binding ember.

3. The sheet binding device according to claim 1, wherein the clamping means forms a gap through which the binding member fed from the feeding means can pass and clamps the binding member passing through the gap from a top and a bottom of the binding member.

4. The sheet binding device according to claim 1, wherein the winding means clamps the binding member fed from the feeding means by the clamping means after the binding member passes through a gap of the clamping means by a fixed amount and is projected from the clamping means and when rotating the clamping means round an outer periphery of the sheets, rotates the clamping means so that the projected binding member is positioned inside a rotation locus.

5. The sheet binding device according to claim 1, wherein the strap holding member comprises a rotatable cylindrical body and includes one end supported and the other end with a contact portion arranged, when adjusting the angle, permits the contact portion to make contact with the binding member and rotates the cylindrical body, and when preventing loosening after the binding member is wound up, rotates more the cylindrical body from a status after the angle adjustment, thereby presses the binding member to the sheets by a pressing surface.

6. The sheet binding device according to claim 1, wherein the conveying means conveys the sheets in the conveying direction, after arrival at a first binding position, in synchronization with rotation of the winding means clamping the binding member, conveys more the sheets in the conveying direction, and when the winding means makes one revolution and reaches an initial position, is positioned almost at a center of a bottom of the sheets.

7. A sheet binding method comprising:
a first step of conveying sheets up to a binding start position;
a second step of feeding a binding member in a first direction from clamping means to a position where the binding member is projected by a predetermined amount;
a third step of clamping the binding member projected by the predetermined amount by the clamping means;
a fourth step of rotating the clamping means along a periphery of the sheets and during the rotation, conveying furthermore the sheets in the predetermined conveying direction;
a fifth step of pushing the binding member on the sheet side, thereby adjusting an angle between the sheets and the binding member;
a sixth step of feeding the binding member in a second direction opposite to the first direction, thereby binding the sheets; and
a seventh step of pushing the binding member to the sheets, thereby preventing the binding member from loosening.

8. The sheet binding method according to claim 7, further comprising:
an eighth step of cutting off the binding member; and
a ninth step of heat-fusing the binding members.
